(19) United States
(12) Patent Application Publication
(10) Pub. No.: US 2018/0137369 A1
(43) Pub. Date: May 17, 2018

(54) METHOD AND SYSTEM FOR AUTOMATICALLY MANAGING SPACE RELATED RESOURCES

(71) Applicant: POINTGRAB LTD., HOD HASHARON (IL)

(72) Inventors: ITAMAR ROTH, TEL-AVIV (IL); HAIM PERSKI, HOD HASHARON (IL)

(21) Appl. No.: 15/426,073

(22) Filed: Feb. 7, 2017

(30) Foreign Application Priority Data
Nov. 13, 2016 (IL) 248942
Nov. 14, 2016 (IL) 248974

(51) Int. Cl. G06K 9/00

(52) U.S. Cl. CPC G06K 9/00771; G06K 9/00369; G06K 9/00335; G06K 9/00362; G06K 9/00342; G06K 9/00805; G06K 9/00228

(57) ABSTRACT

Automatically managing space related resources by using a processor to detect an occupied work station in at least one image of a sequence of images of a space and outputting a signal based on the detection of the occupied work station.

### CROSS-REFERENCE TO RELATED APPLICATIONS

This application claims the benefit of priority from Israel Patent Application No. 248942, filed Nov. 13, 2016, and Israel Patent Application No. 248974, filed Nov. 14, 2016, the disclosures of which are incorporated herein by reference.

### FIELD

The present invention is in the field of image analysis, specifically, the use of image analysis to manage space related resources.

### BACKGROUND

The ability to detect and monitor occupancy in a space, such as a room or building, enables planning and controlling building systems for better space utilization, to minimize energy use, for security systems and more.

Hot desking, or hoteling, refers to an office organization system in which a single physical work space is used by multiple workers for efficient space utilization. Hot desking software usually allow companies to manage many space-related resources such as conference rooms, desks, offices, and project rooms. A wireless occupancy sensor named OccupEye™ includes an integrated PIR (passive infra-red sensor), wireless transmitter and internal antenna and is designed to be mounted under a desk. Networked receivers receive data from the sensors and deliver the data to a standard PC acting as a data logging server where the data is automatically transferred to analytical software, usually in the cloud.

A relatively large number of PIR sensors must be used (at least one for each desk) and depending on construction barriers in the office the PIR based occupancy sensor may be indiscriminate enough to be inaccurate. Additionally, a PIR based sensor can provide only limited information regarding movement of specific workers between desks or other information which may be of interest for office space utilization analysis, for example, locations of work stations such as desks or the location of workers in the space and/or in relation to their work station.

Locations of work stations within a space of a building, which are typically required for efficient hot desking, are usually derived from the building floor plan or provided by the building management. Current hot desking methods do not enable automatic updating of work station locations. Thus, in a case where a work station has been moved from its original location in the building floor plan, the new (actual) location of the work station is not visible to the hot desking system.

### SUMMARY

Embodiments of the invention provide a method and system for automatically identifying an occupied work station in a space, based on image analysis of images of the space. Information derived from images of the space, according to embodiments of the invention, enables efficient allocation of work stations to occupants (such as workers) and automatic, easy and immediate updating of space management systems.

Embodiments of the invention use a processor to detect an occupied station (e.g., work station, such as a desk) in an image of a space (e.g., office).

In one embodiment the invention includes using the processor to determine a location of a work station in the space. The determined location and the information from the images of the space may be used to determine that a work station is occupied.

### BRIEF DESCRIPTION OF THE DRAWINGS

The invention will now be described in relation to certain examples and embodiments with reference to the following illustrative drawing figures so that it may be more fully understood. In the drawings:

FIGS. 1A, 1B and 1C are schematic illustrations of systems according to embodiments of the invention;

FIGS. 2A, 2B, 2C, 2D and 2E are schematic illustrations of methods for automatically managing space related resources, according to embodiments of the invention;

FIGS. 3A and 3B are schematic illustrations of method for automatically managing space related resources by detecting a work station and an occupant in vicinity of the work station, according to embodiments of the invention;

FIG. 4 is a schematic illustration of a method for automatically managing space related resources by detecting an occupied work station in images of a space, according to one embodiment of the invention;

FIG. 5 is a schematic illustration of a method for automatically managing space related resources by detecting an occupied work station in images of a space, according to another embodiment of the invention;

FIG. 6 is a schematic illustration of a method for automatically managing space related resources by tracking an occupant through images of a space, according to an embodiment of the invention; and

FIG. 7 is a schematic illustration of a method for automatically managing space related resources by monitoring an occupied work station in images of a space over time, according to an embodiment of the invention.

### DETAILED DESCRIPTION

Embodiments of the invention provide methods and systems for automatically managing space related resources. The space may be an in-door space (such as a building or parking lot space) or out-door space.

Although examples described herein refer to work stations (such as desks) and allocation of work stations to human occupants, it should be appreciated that embodiments of the invention relate to all types of stations or specific spaces for work purposes or other uses and for any type of occupant.

For example, a work station according to embodiments of the invention may include a desk and the occupant a person. In other embodiments of the invention a work station includes a stall and the occupant an animal. In yet other embodiments a work station includes a parking spot and the occupant a vehicle. Other stations and occupants are included in embodiments of the invention.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

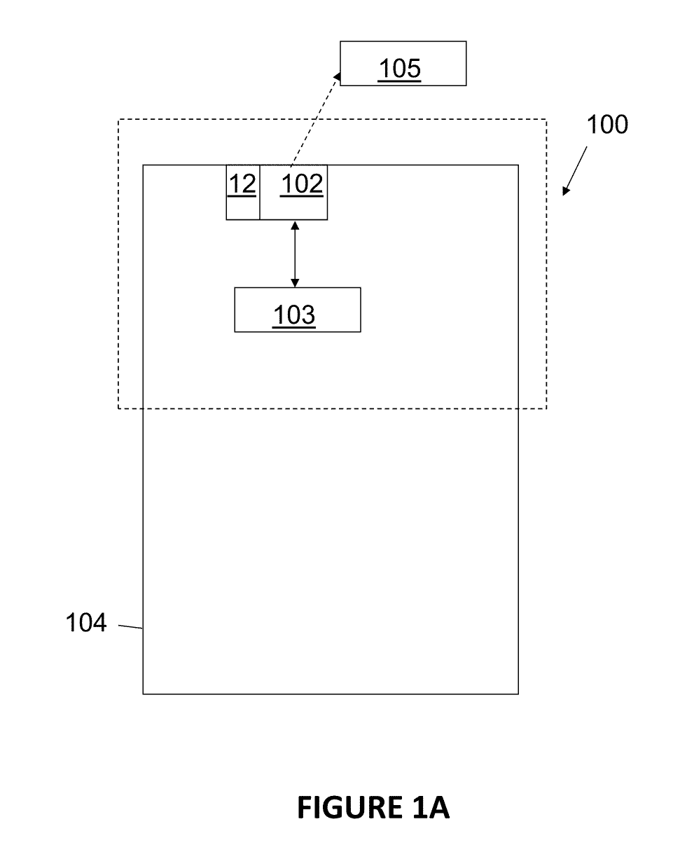

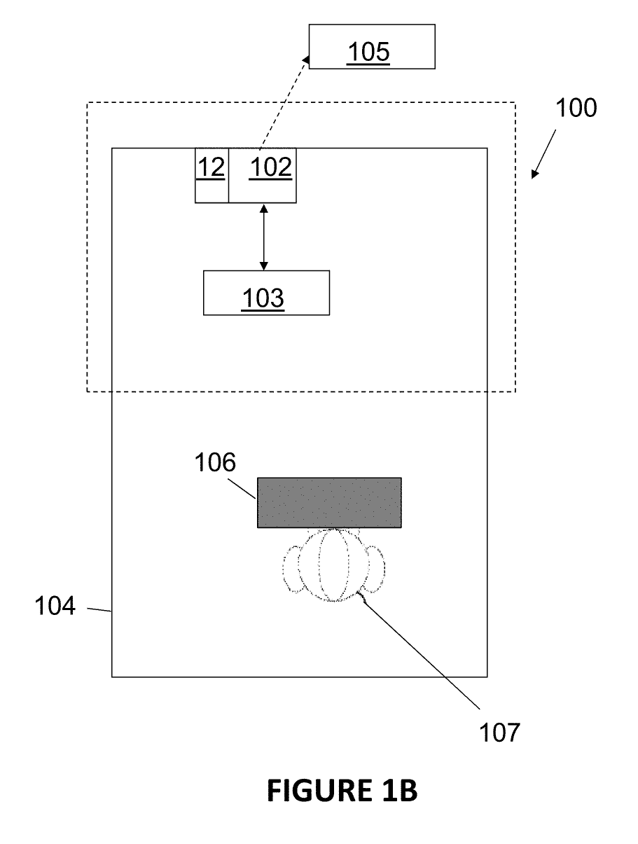

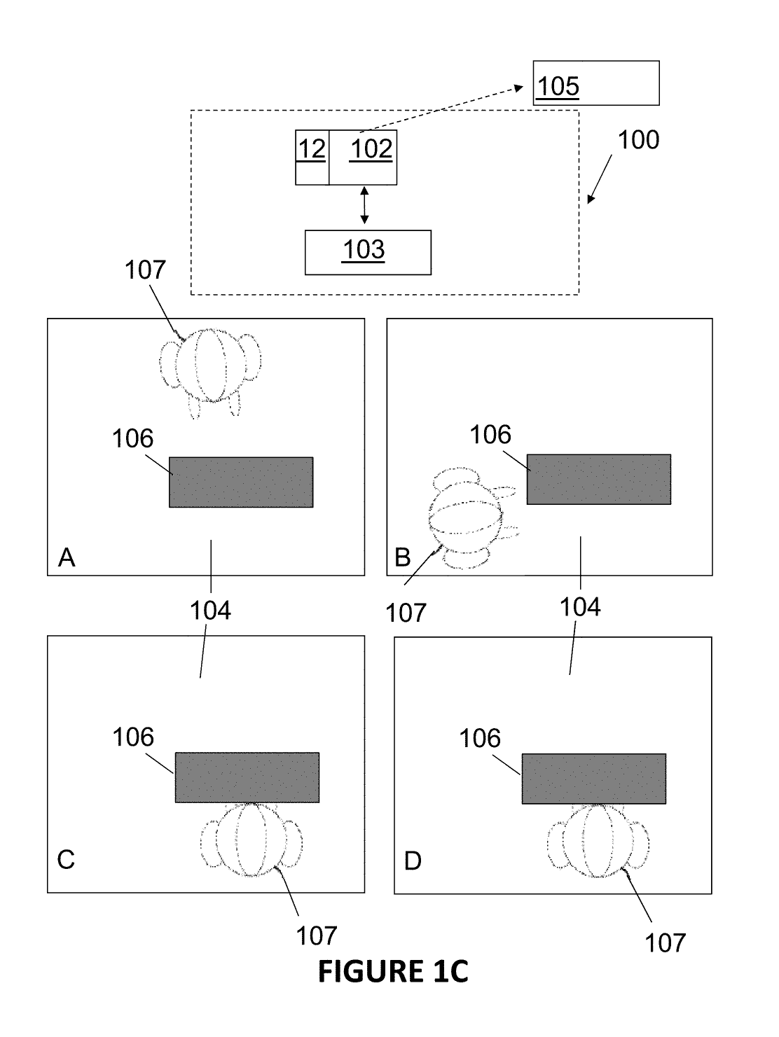

Examples of systems operable according to embodiments of the invention are schematically illustrated in FIGS. 1A, 1B and 1C.

In one embodiment, which is schematically illustrated in FIG. 1A, the system 100 includes one or more image sensor(s) 103 that can obtain images of a space 104. The image sensor 103 is associated with a processor 102 and a memory 12. In one embodiment processor 102 runs algorithms and processes to detect an occupied work station in an image obtained from image sensor 103. An “occupied work station” typically refers to a work station that is to be or has been assigned to an occupant. In some cases, an occupied work station has an occupant currently occupying the work station. In other cases, a work station may be occupied even if no occupant is currently occupying the work station.

In one embodiment, processor 102 may apply shape detection algorithms on images obtained from image sensor 103 to detect an occupied work station by its shape in the image(s).

In some embodiments detecting an occupied work station includes determining a location of the work station and determining from at least one image of the space and from the location of the work station if the work station is an occupied work station.

In one embodiment the location of the work station may be determined by receiving the location, e.g., from a building floor plan or another source. In another embodiment the location of the work station is determined by detecting the work station in an image of the space, e.g. by applying shape detection or object detection algorithms on an image of the space to detect a shape of a work station in the image.

According to one embodiment processor 102 runs algorithms to identify a work station in a space based on tracking of an occupant through images of the space. Processor 102 may run algorithms and processes to detect and track an occupant to different locations in the space imaged by image sensor(s) 103 and to create an occupancy map which may include, for example, a “heat map” of the occupant's locations in the space, and to determine the location and/or other characteristics of the work station based on the heat map.

Objects, such as occupants, may be tracked by processor 102 through a sequence of images of the space using known tracking techniques such as optical flow or other suitable methods. In one embodiment an occupant is tracked based on his shape in the image. For example, an occupant is identified in a first image from a sequence of images as an object having a shape of a human form. A selected feature from within the human form shaped object is tracked. Shape recognition algorithms are applied at a suspected location of the human form shaped object in a subsequent image from the sequence of images to detect a shape of a human form in the subsequent image and a new selected feature from within the detected shape of the human form is then tracked, thereby providing verification and updating of the location of the human form shaped object.

In one embodiment the processor 102 is to identify a location of the occupant in an image and to determine that the location of the work station is the same location of the occupant in the image if the occupant is immobile at the identified location for a time above a predetermined threshold.

In another embodiment the processor 102 is to identify a body position of the occupant (e.g., a standing person vs a sitting person) and to identify the work station based on tracking of the occupant, based on location of the occupant and based on the body position of the occupant.

In one embodiment, based on the detection of an occupied work station, a signal is output, for example, to an external device 105, which may include a central server or cloud. The output signal may be further analyzed at external device 105. For example, external device 105 may include a processing unit that uses the output from processor 102 (or from a plurality of processors connected to a plurality of image sensors) to update statistics of the space 104. For example, space 104 may include at least part of an office building space and output based on detection of an occupied work station in the office building space may be used to update the office building statistics data (e.g., the number of available workstations in the office building is updated). In another embodiment the output based on detection of a work station in the office building space may be used to update the floorplan of the building (e.g., update the number of workstations in the office building, their location, their dimensions and more).

In some embodiments device 105 may include a display and output based on detection of a location of a work station and/or the detection of an occupied work station in the office building space may be used to update the graphical interface of the display, for example, to show occupied and available work stations in a graphical display and/or to show an updated floorplan in a graphical display.

In some embodiments output from processor 102 may be used by space related resources management system software (e.g., a smart building management system) to assign work stations in the space to occupants.

In some embodiments a system, such as a smart building management system, may use output from processor 102 to cause a visual indication to appear in vicinity of an occupied work station. For example, once a work station is assigned to an occupant (e.g., an “occupied” signal is generated in connection with the work station by processor 102) a signal may be sent to light up an LED or other visual indicator above the work station so that occupants are advised of the “occupied” status of this work station.

The processor 102 may be in wired or wireless communication with device 105 and/or with other devices and other processors. For example, a signal generated by processor 102 may activate a process within the processor 102 or may be transmitted to another processor or device to activate a process at the other processor or device.

A counter to count occupied work stations in the space 104 may be included in the system 100. The counter may be part of processor 102 or may be part of another processor that accepts output, such as a signal, from processor 102.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Processor 102 is typically associated with memory unit(s) 12, which may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

According to some embodiments images obtained by the image sensor 103 are stored in memory 12. In one embodiment images obtained by the image sensor 103 are 2D images. The 2D images may be analyzed by processor 102 using image analysis methods, such as color detection, shape detection and motion detection or a combination of these and/or other computer vision methods.

For example, shape detection (or recognition) algorithms may include known shape detection methods such as an algorithm which calculates features in a Viola-Jones object detection framework. In another example, the processor 102 may run shape detection algorithms which include machine learning processes. For example, a machine learning process used to detect an occupant and/or a work station and/or an occupied work station, according to embodiments of the invention, may run a set of algorithms that use multiple processing layers on an image to identify desired image features (image features may include any information obtainable from an image, e.g., the existence of objects or parts of objects, their location, their type and more). Each processing layer receives input from the layer below and produces output that is given to the layer above, until the highest layer produces the desired image features. Based on identification of the desired image features an object such as an occupied or unoccupied work station or an occupant may be detected or identified. Motion in images may be identified similarly using a machine learning process. Objects, such as occupants, may be tracked through a set of images of the space using known tracking techniques such as optical flow or other suitable methods.

In one embodiment the image sensor 103 is designed to obtain a top view of a space. For example, the image sensor 103 may be located on a ceiling of space 104, typically in parallel to the floor of space 104, to obtain a top view image of the space or of part of the space 104.

Processor 102 may run processes to enable identification of objects such as work stations and/or of occupants, such as humans, from a top view, e.g., by using rotation invariant features to identify a shape of an object or person or by using learning examples for a machine learning process including images of top views of objects such as work stations or other types of stations and of people or other types of occupants.

In one embodiment, which is schematically illustrated in FIG. 1B the system 100 detects an occupied work station by detecting a work station 106 in an image of the space 104 and detecting an occupant 107 in the vicinity of the work station 106. Detection of the work station 106 and/or the occupant 107 may be done by processor 102, for example, by applying shape detection algorithms (e.g., as described above) on one or more images obtained by image sensor 103 to detect a shape of an occupied work station (e.g., a shape of a desk with a person sitting by the desk) and/or to detect a shape of work station and/or of an occupant.

In one embodiment, which is schematically exemplified in FIG. 1C, the system 100 identifies a location and/or other characteristics of a work station 106 based on a motion pattern of a tracked occupant (e.g., a motion pattern of a tracked occupant may be part of an occupancy map, as described above).

In FIG. 1C the occupant 107 is shown moving through a space 104 to a work station 106 and once at the work station 106, shown sitting by the work station 106. This sequence of events is depicted in sequential images A, B, C and D. Typically, the motion pattern of the occupant 107 in images A and B (in which the occupant 107 is moving through the space 104) includes relatively large movements and a big change between image A and image B. The motion pattern of the occupant 107 in images C and D (where the occupant 107 is sitting by the work station 106) includes relatively small movements and small changes between the images. Thus, in this example, when the motion pattern of the occupant 107 has changed from large movements to small movements at a specific location (namely, the occupant's 107 location in image C and D), and/or when the occupant 107 is immobile for a time above a predetermined threshold at that location, that location can be determined to be the location of the work station 106.

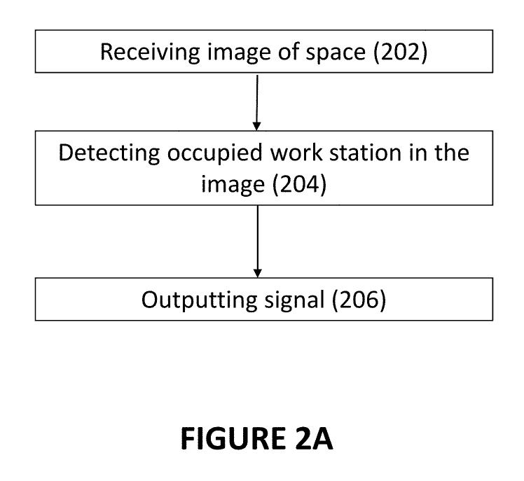

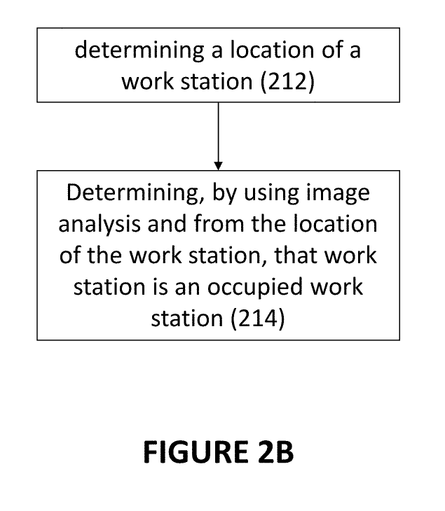

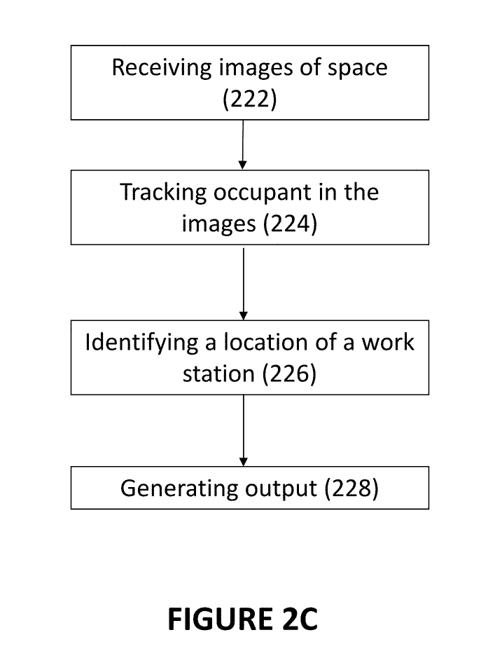

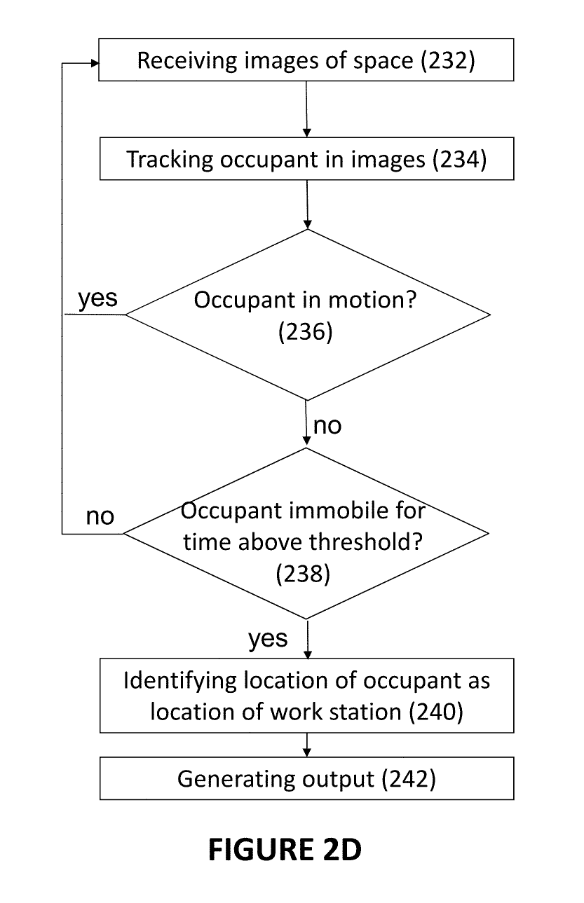

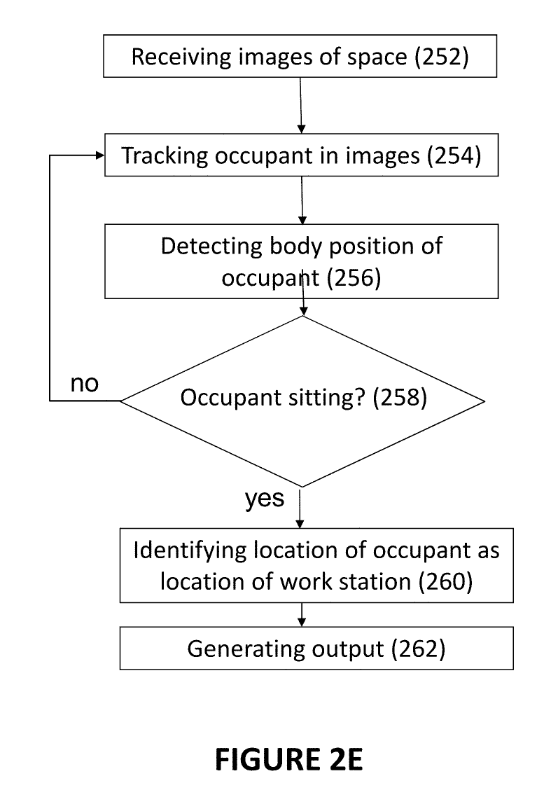

In one embodiment a method run by processor 102, for automatically managing space related resources, includes using a processor to detect an occupied work station in at least one image of a sequence of images of a space and outputting a signal based on the detection of the occupied work station. In one example which is schematically illustrated in FIG. 2A the method includes receiving one or more images of a space (202). An occupied work station is detected in the one or more images (204), using image analysis methods, and a signal is output based on the detection of the occupied work station (206).

In one embodiment an occupied work station is detected from images of the space based on the shape of an occupied workstation. For example, the dimensions and/or outline of an object in an image which represents a desk having a person seated by it is different than the dimensions and/or outline of an unoccupied desk. Thus, in one embodiment the method includes detecting a shape of the occupied work station, e.g., by applying a shape detection algorithm on one or more images to detect an occupied work station in the image.

In one embodiment, which is schematically illustrated in FIG. 2B, the method includes determining a location of a work station (212) and determining from at least one image of the space (by using image analysis) and from the location of the work station, that the work station is an occupied work station (214).

Location of a work station may be determined by receiving the location (e.g., from a building floorplan and/or from another source). In some embodiments the location of the work station may be determined by detecting the work station in an image of the space (e.g., by detecting the shape of a work station in the image of the space), as further detailed below. In another embodiment the location of the work station may be determined by tracking an occupant throughout the space to obtain an occupancy map. Tracking an occupant throughout the space may be done by non-visual methods, e.g., using presence detectors such as PIR sensors or other presence detectors or by visual methods, e.g., tracking an occupant in images of the space.

In one example, which is schematically illustrated in FIG. 2C, the method includes receiving images of space (222), tracking an occupant in the images (224) and identifying a location (and/or characterization) of a work station (226) based on the tracking. An output is generated based on the identification of the location (and/or characterization) of the work station (228).

The output may be sent to another device (e.g., a server) or storage place (e.g., cloud) and may be used, e.g., by the server, to update building statistics and/or may be used to update a building floor plan.

Characterization of a work station may include features such as location of the work station, size and/or shape of the work station etc. The characterization of the work station may be identified based on the motion pattern of a tracked occupant. For example, an occupant may have to walk around his desk in order to sit down behind the desk. This would be detected by a processor tracking the occupant as a repetitive path of the occupant in vicinity of the desk. The repetitive path may be analyzed to detect from it the shape and/or length or dimensions of the desk. The detected shape (or other features) can be output to a central server or other device as part of the output generated at the processor.

In one embodiment the characterization or feature of the work station which is identified based on tracking of an occupant is the location of the workstation in the space. As discussed above, a processor may calculate a location of the occupant (e.g., based on a shape of the occupant) in an image. Thus, location of the occupant in the image at a point where the occupant's motion pattern indicates that he is, for example, sitting at a workstation, can be calculated and can be determined to be the location of the workstation in the image.

In one embodiment the location of the work station in the real-world space can be identified based on the location of the work station in the image (as further described below).

In one embodiment the method includes detecting a shape of the occupant and tracking the shape of the occupant, e.g., as described above.

In one embodiment, the method includes tracking the occupant to a location in the space and if the occupant is immobile at that location for a time above a predetermined threshold (e.g., the occupant is immobile for 30 minutes), then that location is identified as the location of a work station.

In one embodiment determining the location of the work station includes obtaining an occupancy map of the space and determining the location of the work station based on the map. An occupancy map typically depicts locations of occupants in the space, over time.

The occupancy map may be constructed using, for example, values that represent occupancy status (e.g., occupied by an occupant or not) per location, duration of occupancy at each location, etc. Thus, a map may be obtained that depicts which locations in the space are often occupied and which locations are occupied for longer periods than others.

Obtaining an occupancy map may include tracking an occupant in a sequence of images of the space. In another embodiment an occupancy map may be obtained by tracking occupants by non-visual methods, e.g., using presence detectors such as PIR sensors or other presence detectors.

In one embodiment a received location of a work station (e.g., provided by the building management) is compared to the location of the work station determined based on an occupancy map and an output is generated based on the comparison. For example, if there is a discrepancy between the location of the work station determined based on the occupancy map and the received location a notice may be output to the building management.

In one example which is schematically illustrated in FIG. 2D, the method includes receiving a sequence of images of a space (232) and tracking an occupant in the images (234). If the occupant is in motion (236) then the tracking is continued. However, if the occupant is not in motion and if it is determined that the occupant is immobile for a time above a predetermined threshold (238), then the location of the occupant in an image is identified as the location of the work station (240). Output is then generated based on the identification of the location of the workstation (242). The location of the work station can be the location in the image and/or the location in the (real-world) space.

A time period above a predetermined threshold may be determined for example, by a number of consecutive images in which the occupant is immobile. For example, if the occupant is determined to be immobile in a number of consecutive images above a predetermined threshold (e.g., in a system imaging at a rate of 10 frames per second the threshold may be 18,000 images), then the location of the occupant in an image is identified as the location of the work station.

In another embodiment, which is schematically illustrated in FIG. 2E, the method includes receiving a sequence of images of a space (252) and tracking an occupant in the images (254). The occupant's body position is detected in an image from the sequence of images (256). If it is determined that the occupant is sitting or reclining in the image (258) then the location of the occupant in that image is identified as the location of the workstation (260). Output is then generated based on the identification of the location of the workstation (262) (which may be the location in the image and/or the location in the space).

If the occupant is not sitting or reclining in the image, then tracking of the occupant is continued.

In some embodiments if it is determined that the occupant is sitting or reclining in images for a time above a predetermined threshold (e.g., above 10 minutes) then the location of the occupant in that image is identified as the location of the workstation. In one embodiment, if a sitting body position of the occupant is detected in a number of consecutive images above a threshold number (e.g., in a system imaging at a rate of 10 frames per second the threshold may be 6,000 images), then the location of the occupant in that image is identified as the location of the workstation.

Other methods for detecting an occupied work station in images of the space may be used. Some examples are described below.

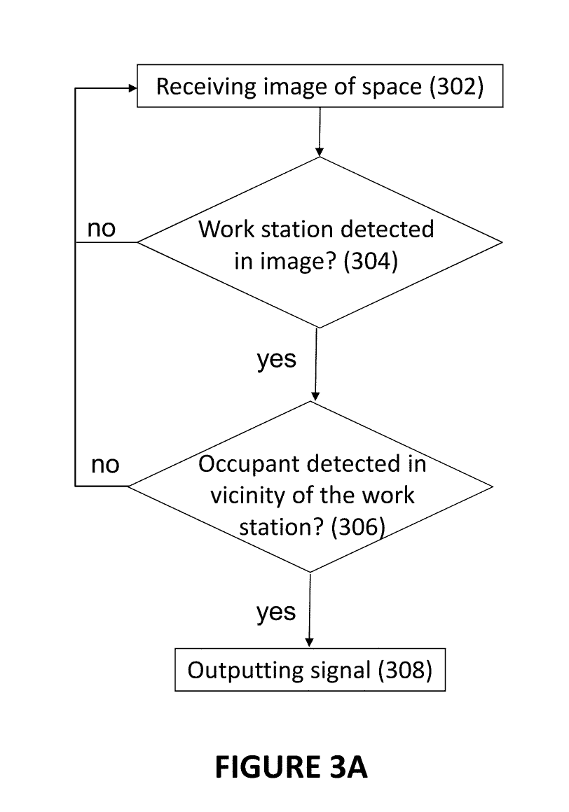

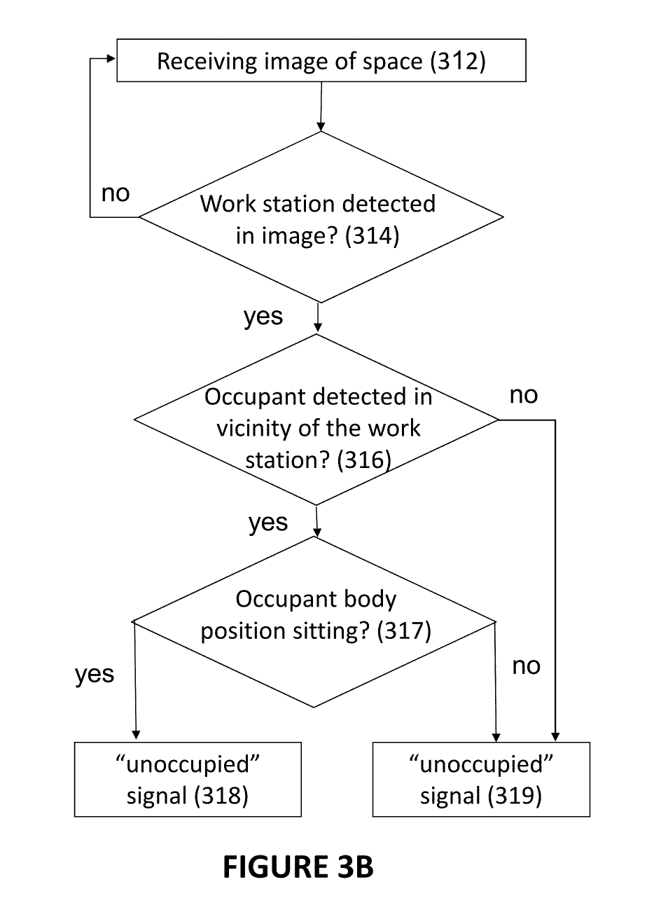

In one embodiment, which is schematically illustrated in FIG. 3A, a method includes receiving one or more images of a space (302) and if a work station is detected in one or more images (304) and an occupant is detected in the one or more images in vicinity of the work station (306) then a signal is output (308) (e.g., a signal to mark the work station “occupied”). If a work station is not detected in the one or more images (304) and/or an occupant is not detected in vicinity of the work station (306) then a subsequent image(s) is analyzed for the presence of a work stations and/or for the presence of an occupant in vicinity to the work station.

Vicinity of a work station may be a predetermined range from the work station. In one embodiment, the method includes detecting an occupant in an image and if the location of the detected occupant is within a predetermined range from the work station, then determining that the work station is an occupied work station.

Detecting the work station and/or detecting an occupant in an image may include detecting a shape of the work station and/or occupant in the image.

Vicinity of the occupant to the work station or the range from the work station may be determined, for example, based on distance of the occupant from the work station in the image (measured for example in pixels) or vicinity in real-world distances (e.g., if an occupant is within a predetermined radius of the work station, e.g., 0.5 meter).

A processor (e.g., processor 102) may determine distance of an occupant from a work station (in an image and/or in real-world distance). In one embodiment the method includes detecting a shape of the work station. In another embodiment the method includes detecting a shape of the occupant. The shape of the work station and/or of the occupant may be 2D shapes.

In one embodiment, typically when analyzing top view images of a space, a processor may determine, from the detected shape of the work station and/or occupant, the location of the work station and/or occupant on the floor of the space in the image. The location on the floor in the image may then be transformed to a real-world location by the processor. The shape of the work station and/or occupant may be used to determine their location on the floor of the space in the image by, for example, determining a projection of the center of mass of the work station and/or occupant which can be extracted from the work station's and/or occupant's shape in the image, to a location on the floor. In another embodiment the location of an occupant on the floor in the image may be determined by identifying the feet of the occupant based on the detected shape of the occupant. The location of the feet in the image is determined to be the location of the occupant on the floor in the image. A processor may then transform the location on the floor in the image to a real world location by using, for example, projective geometry.

In some embodiments the method includes determining a body position (e.g., standing vs. sitting or reclining) of the occupant in the one or more images and determining that the work station is occupied based on the determined body position of the occupant.

A body position of an occupant may be determined based on the shape of the occupant. In one embodiment the visual surrounding of the shape of the occupant in the image may be used to assist in determining the body position of the occupant. For example, the shape of an occupant in a 2D top view image may be similar to the shape of a standing occupant however based on the visual surrounding of the shape of the occupant it may be determined that the person is sitting, not standing.

Thus, in one embodiment the method may include detecting a work station in one or more images of a space and detecting a body position of an occupant in vicinity of the work station. If the body position is a predetermined position (e.g., if it is determined that the occupant is sitting) then an “occupied” signal may be output. However, if it is determined that the occupant is not in vicinity of the work station or the occupant is in vicinity of the work station but the body position of the occupant is other than a sitting or reclining body position then an “occupied” signal is not output or, alternatively, an “unoccupied” signal may be output. The decision of outputting an “occupied” signal could be a time dependent decision. For example, an “occupied” signal may be output, in some embodiments, only if an occupant is sitting (or in another predetermined body position) in vicinity of the work station for a period of time above a threshold.

In one embodiment, which is schematically illustrated in FIG. 3B, a method includes receiving one or more images of a space (312) and if a work station is detected in one or more images (314) and an occupant is detected in the one or more images in vicinity of the work station (316) and if the body position of the occupant is sitting or reclining (317) then an “occupied” signal is output (318) (e.g., by processor 102). If the body position of the occupant is not sitting or reclining (e.g., the occupant's body position is standing) (318) and/or if the occupant is not detected in the vicinity of the workstation then an “unoccupied” signal is output (319).

If a work station is not detected in the one or more images (314) then a subsequent image(s) is analyzed for the presence of a work station and/or for the presence of an occupant in vicinity to the work station.

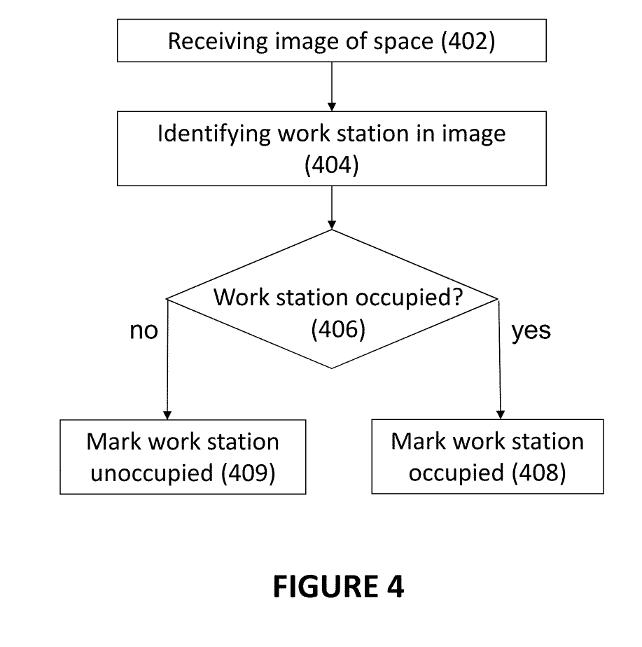

In one embodiment, which is schematically illustrated in FIG. 4, a method, which may be performed using a processor, such as processor 102, includes receiving one or more images of a space (402), detecting a work station in at least one image of a space (404) and determining from the image if the work station is occupied (406). If the work station is occupied then a signal is output based on the detection of the occupied work station. For example, the output may include a signal to mark the work station occupied (408). If the detected work station is unoccupied then either no output is generated or an output may be generated to mark the workstation unoccupied (409).

As discussed above, in some embodiments a work station (occupied or unoccupied) is detected from image data of the space. For example, detecting a work station from image data may include detecting a shape of the work station in the image (e.g., by applying shape detection algorithms). In other embodiments detecting a work station from image data may include detecting a color(s) of the work station (optionally in addition to detecting a shape of the work station) (e.g., by applying color detection algorithms).

In other embodiments identification of the work station in the image of the space is done using information external to the image data, e.g., by receiving an indication of the work station in the image. For example, a floor plan of an office building may be used by processor 102 to indicate locations of work stations on the floor space that is within the field of view of the imager obtaining the images (e.g., image sensor 103). In another example, locations of work stations may be supplied manually. A location of a work station supplied through such external information may be translated to location in the image and may then be used to calculate distance of occupants from work stations, as discussed above.

Determining if the workstation is occupied (step 406) is typically done using image analysis techniques, namely, determining if the workstation is occupied from image data of the space.

In one embodiment determining if the workstation is occupied is done by detecting an occupant in vicinity or within a predetermined range of the work station in the image (e.g., as described above). In other embodiments determining if the workstation is occupied includes detecting predetermined items on or in vicinity of the work station. Predetermined items may include, for example, objects which are typically placed on a desk by an occupant, for example a cellular phone and/or laptop computer. Predetermined items may be detected by using object detection techniques (e.g., using shape and/or color detection).

In some embodiments determining if the work station is occupied may include monitoring the work station over time in several images and determining occupancy of the work station based on, for example, changes detected over time in vicinity of the work station. For example, if newly added items (e.g., items that are not detected in early images but are detected in later images) are detected on or in the vicinity of the work station, the work station may be determined to be an occupied work station.

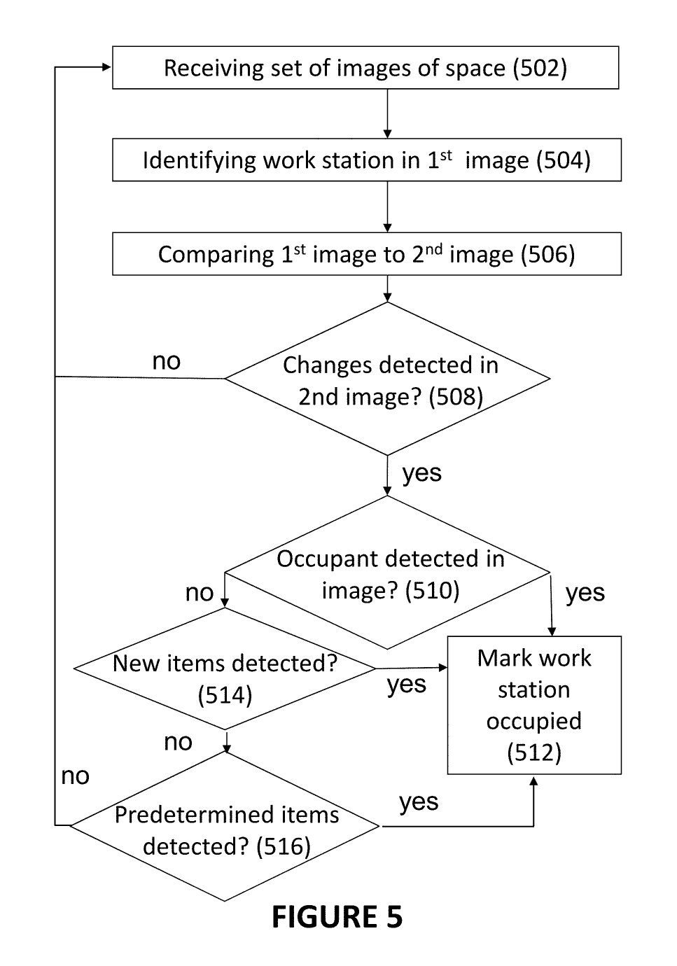

In one example, which is schematically illustrated in FIG. 5, a method includes receiving a set of images of a space (502) and identifying a work station in a first image from the set of images (504). A second, later, image from the set of images is compared to the first image (506) to detect changes in the vicinity of the work station (508). If no changes are detected in the second image additional images are analyzed.

In one embodiment if changes are detected, e.g., an occupant is detected in the second image (510) then a signal to mark the work station “occupied” is generated (512). If no occupant is detected in the second image then, if newly added items are detected in vicinity of the work station in the second image (514), a signal to mark the work station occupied is generated (512). If no occupant and no newly added items are detected in the second image but if predetermined items (e.g., items placed by an occupant) are detected in vicinity of the work station (516) then a signal to mark the work station occupied is generated (512). If no occupant and no newly added items and no predetermined items are detected in the second image, then additional images are analyzed.

In one embodiment if an occupant is detected in vicinity of the work station in an image of the space then that occupant is linked to or assigned to the work station, e.g., by processor 102. If the linked occupant is detected in at least one later, subsequent, image from the sequence of images then it is determined that the work station is an occupied work station.

Thus, in one embodiment the method includes maintaining an “occupied” mark in connection with a work station, even if the occupant is not in vicinity of the work station, if the occupant is detected in subsequent images of the space. Thus, once an occupant is linked to a work station (e.g., by being detected in vicinity of the work station) or assigned to a work station (e.g., by a building management system using signals from processor 102) that work station will be marked occupied as long as the occupant is still within the space (e.g., office building).

Identification of the occupant assigned to a specific work station may be done by detecting the occupant in vicinity of the work station from images as described herein. In other embodiments an occupant may be identified by an RFID signal or by face recognition or other known methods. Once identified, the occupant may be assigned a work station thereby linking an identified occupant to a specific work station. The occupant may then be tracked throughout images of the space.

In one embodiment a unique identity of an occupant may be determined by means of image analysis or other means. The unique identity is associated with the object in the image which represents the occupant. Once a unique identity is associated with a particular object in an image, the object may be tagged or named. Thereafter an image sensor or plurality of image sensors may track the tagged or named object in images of the space without having to verify the identity of the occupant during the tracking.

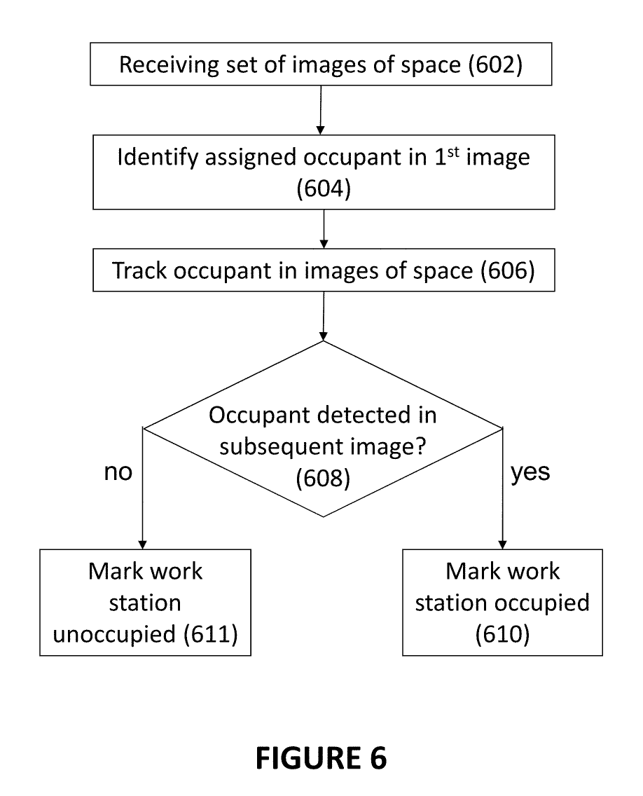

In one embodiment, which is schematically illustrated in FIG. 6, the method includes receiving a set of images of a space (602) and identifying in the images an occupant linked to or assigned to a work station in a first image from the set of images (604). The occupant is then tracked throughout subsequent images of the space (606). If the occupant is detected in at least one, later, image of the space (608) an “occupied” mark may be generated or maintained (610) in connection with the work station. If the occupant is not detected in a subsequent image (608) (typically, not detected in at least several subsequent images) then an occupied mark is either not maintained or an “unoccupied” mark is generated in connection with the work station (611).

In another embodiment if a work station is unoccupied for a long time (e.g., a time period above a predetermined threshold) then a signal is generated to mark the work station unoccupied.

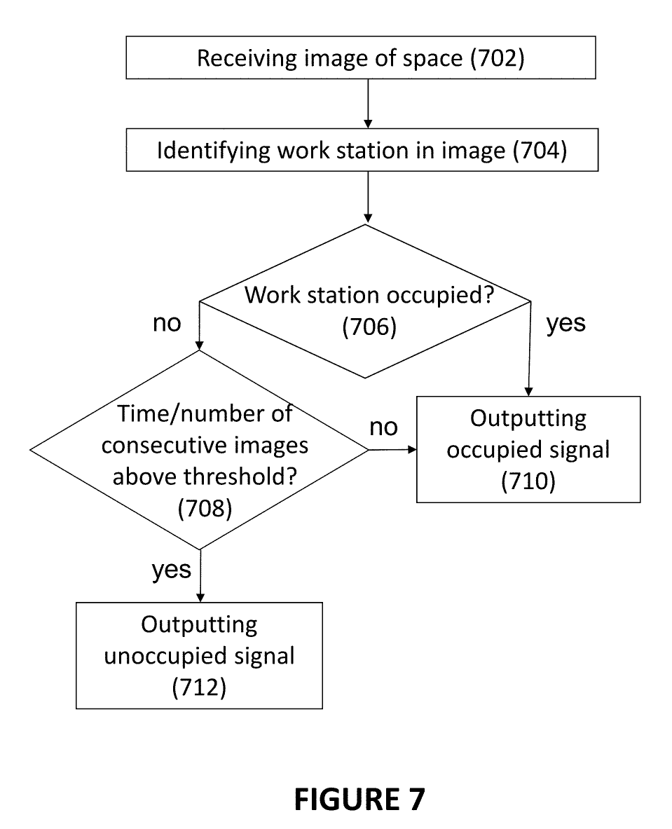

In one embodiment, which is schematically illustrated in FIG. 7, the method includes receiving one or more images of a space (702), identifying a work station in at least one image of a space (704) and determining from the image if the work station is occupied (706). If the work station is occupied (706) then an “occupied” signal is output (710). If the work station is not occupied for a time period of above a predetermined threshold (708) (e.g., the work station is determined to be unoccupied in a number of consecutive images above a predetermined threshold) then no occupied signal is generated or a signal is generated to mark the work station unoccupied (712).

“Occupied” or “unoccupied” signals generated according to embodiments of the invention may be used for automatically and efficiently managing works stations (or other space related resources) in a space.

Embodiments of the invention provide automatic identification of a work station from images of a space, enabling facile and simple updating of space management systems.

1. A method for automatically managing space related resources, the method comprising:
using a processor to
obtain image data of a space, the space comprising a work station,
apply an image analysis algorithm to detect an occupant from the image data,
determine, from the image data, if the occupant is within a predetermined distance from the work station, and
output a signal to update data at an external device to indicate that the work station is occupied, if the occupant is within the predetermined distance from the work station.

2. The method of claim 1 wherein the image analysis algorithm comprises a shape detection algorithm.

3. The method of claim 1 comprising:
determining a location of the work station; and
determining if the occupant is within the predetermined distance from the work station based on the location of the work station.

4. The method of claim 3 wherein determining a location of the work station comprises receiving the location of the work station.

5. The method of claim 3 wherein determining a location of the work station comprises using the processor to detect the work station from the image data.

6. The method of claim 5 wherein detecting the work station from the image data comprises detecting a shape of the work station from the image data.

7. The method of claim 3 wherein determining a location of the work station comprises:
obtaining an occupancy map of the space; and
determining the location of the work station based on the occupancy map.

8. The method of claim 7 wherein obtaining an occupancy map comprises tracking an occupant in a sequence of images of the space.

9. The method of claim 21 comprising:
using the processor to generate the output to update a location of the work station on a floor plan based on a discrepancy between the determined location of the work station and a received location of the work station.

10. (canceled)

11. (canceled)

12. The method of claim 1 comprising:
determining, from the image data, a body position of the detected occupant; and;
outputting a signal to update data at the external device to indicate that the work station is occupied if the occupant is within the predetermined distance from the work station and based on the determined body position of the occupant.

13. The method of claim 12 wherein determining a body position of the occupant comprises detecting a shape of the occupant from the image data.

14. The method of claim 12 comprising outputting a signal to update data at the external device to indicate that the work station is occupied if the body position of the occupant is a sitting position.

15. The method of claim 1 comprising:
detecting from the image data predetermined items in vicinity of the work station; and
outputting a signal to update data at the external device to indicate that the work station is occupied if the occupant is within the predetermined distance from the work station and based on detection of the predetermined items

16. The method of claim 1 comprising:
detecting from the image data newly added items in vicinity of the work station; and
outputting a signal to update data at the external device to indicate that the work station is occupied if the occupant is within the predetermined distance from the work station and based on detection of the newly added items.

17. The method of claim 1 comprising:
linking an occupant to a work station detected from a first image data of the space; and
if the linked occupant is detected in image data of the space which is obtained subsequent to the first image data, then determining that the work station is occupied.

18. A system comprising:
an image sensor to obtain an image of a space; and
a processor to
detect an occupied work station in the space if an occupant is detected in the image of the space within a predetermined distance from the work station, and
output a signal to update data at an external device based on the detection of the occupied work station.

19. The system of claim 18 wherein the processor is to apply a shape detection algorithm to detect the work station.

20. The system of claim 18 wherein the processor is configured to:
receive a location of the work station in the space,
determine a location of the work station in the image,
compare the received location to the determined location, and
update data at the external device based on the comparison.

21. The method of claim 7 comprising:
generating output to update a location of the work station on a floor plan based on the determined location of the work station.

22. The method of claim 1 comprising using the processor to output a signal to update data at an external device to indicate that the work station is occupied, if the occupant is in vicinity of the work station for a period above a predetermined threshold.
